(19) United States
(12) Patent Application Publication
(10) Pub. No.: US 2012/0112704 A1
(43) Pub. Date: May 10, 2012

(54) SYSTEM AND METHOD FOR PULSING THE BLEED OFF RESISTOR WITHIN A BATTERY MANAGEMENT SYSTEM

(76) Inventor: Joseph Gottlieb, (US)

(21) Appl. No.: 12/941,815

(22) Filed: Nov. 8, 2010

(51) Int. Cl. H02J 7/04

(52) U.S. Cl. 320/150

(57) ABSTRACT

The present invention relates generally to a method and apparatus for the management of individual cells in a battery system. More particularly, the present invention relates to the control of power and when charging a battery system to yield the most efficient charging solution while maintaining the desired temperature.

### TECHNICAL FIELD

The present invention relates generally to a method and apparatus for the management of individual cells in a battery system. More particularly, the present invention relates to the control of power and when charging a battery system to yield the most efficient charging solution while maintaining the desired temperature.

### BACKGROUND

Typically, battery systems, such as battery strings or strings, include a plurality of individual cells. A “cell” can mean a single electrochemical cell comprised of the most basic units, i.e. a positive plate, a negative plate, and an electrolyte. However, as used herein, the term is not so limited and may include a group of basic cells that can comprise a single unit as a component of a battery string and the use of the latest in battery chemistries i.e. lithium and lithium combinations. A battery or battery string is a series or parallel connection of units or individual cells.

There is a tendency for each cell within individual batteries, when connected in series, to have different characteristics, such as energy storage capacity and discharge rates. These differences are caused be many variables including, but not limited to, temperature, initial tolerances, material impurities, porosity, electrolyte density, surface contamination, and age. A low-capacity cell will typically charge and discharge more rapidly than the other cells. An overly charged and discharged cell develops poor recharging characteristics and can be permanently damaged. A damaged cell will affect the operating characteristics of the entire battery string. The damaged battery will have lower capacity and will become discharged more rapidly than a healthy battery. The failure of an individual cell can cause substantial damage to the battery system and accompanying equipment. Therefore, a need exists for a system to monitor individual or group of cells and to prevent overly charging and discharging of cells.

Various mechanisms have been developed to monitor and charge cells in a battery string. The classical means for controlling a battery is to balance the cells through equalization charging. This involves passing a low current through the battery string thus charging the low cells while the fully charged cells become overcharged. It is done at a low current to minimize damage to the fully charged cells. However, balancing using this method is a slow process and can damage certain battery chemistries.

The use of a battery management system to overcome over charging and discharging of the batteries is well known in the art. Typically a battery management system monitors the charging and discharging of the batteries, by monitoring unit parameters such as voltage, of the batteries which is then recorded and analyzed by a microprocessor to determine the condition and state of each cell in the battery string. Additionally it is common for a battery management system to control bleed off resisters connected to an individual cell such that the bleed of resistor is bleeding off unwanted energy provided to that cell while charging a battery string. Although the use of this type of battery management systems resolves many problems it is still limited when a charge is applied to a battery string in that the battery management system can only discharge the amount of current equal to the resistance value of the bleed off resistor. Such that in the event one cell is charged quicker than another the bleed off resister can only bleed off the energy equivalent to the value of the bleed off resistor and therefore the one cell may still receive unwanted current and therefore become overcharged thereby damaging the cell. In such event the only solution would be to reduce the overall charge to the battery string thereby lengthening the time it takes to recharge the battery string.

### SUMMARY

The deficiencies of the prior art are substantially overcome by the battery management system of the present invention which includes the method of pulsing the bleed off resistor such that the bleed off resistor does not overheat.

In a preferred embodiment of the present invention four cells can be logically placed in a battery string having a battery management system or a plurality of battery strings having a battery management system. The battery management system includes a bleed off resistor for each cell and a temperature sensor monitoring each cell or the string of cells. At full charge the voltage level of each cell is at 3.6 volts whereas a depleted cell would read 2.5 volts. In a string of cells one battery may charge quicker than the others. High current can be passed through the string to quickly charge each cell. In the event one cell in the string becomes charged sooner the battery management system is smartly configured utilizing the control of a microprocessor to connect the bleed off resistor to that charged cell thereby causing power to bleed off of that cell such that the cell is not overly charged and the total power to the string does not have to be reduced until all cells in the string are fully charged and read 3.6 volts. Under the present invention the microprocessor is smartly configured with a temperature sensor such that the microprocessor will disconnect the bleed off resistor at a temperature level determined to be detrimental to the system. Additionally the microprocessor is smartly configured to connect the bleed off resister again when the bleed off resister is cooled to a heat determined to be safe to bleed off additional power from the cell.

Another particularly innovative aspect of the present invention is realized when the temperature level determined to be detrimental to the system is reached the microprocessor is smartly configured to pulse the connection of the bleed off resister to the cell such that energy is still bleeding off and the temperature can be maintained at a desired level. This enables the ability to continue bleeding off of unwanted current instead of disconnecting the bleed off resister leaving the battery vulnerable to over charging or reducing the charging of the battery string such that the recharging of the battery string takes longer. It is further realized that one can exceed the wattage rating of the bleed off resistor for a short time in an effort to bleed off more heat as long as the bleed off resister can be pulsed to maintain a desired temperature.

### BRIEF DESCRIPTION OF THE DRAWINGS

FIG. 1 is a block diagram representing prior art

FIG. 2 is a block diagram illustrating one embodiment of the invention

FIG. 3, represents a battery string

FIG. 4, is a graph representing the effects of pulsing the bleed off resistor connection to a cell

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

A portion may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, logic elements, look-up tables, or the like, which may carry out a variety of functions under the control of one or more microprocessors or other control devices. In addition, those skilled in the art will appreciate that the present invention may be practiced in conjunction with any number of batteries, battery management systems, controllers and that the system described herein is merely one exemplary application for the invention.

The overall purpose of the battery management system is to automatically manage each individual battery cell, one of a plurality of cells in a battery such that the overall health of the cell is maintained. Maintaining battery health requires monitoring of key parameters of the battery in various states. Such key parameters include current being applied to each cell, current bleeding off at each cell, current being drained from each cell and temperature.

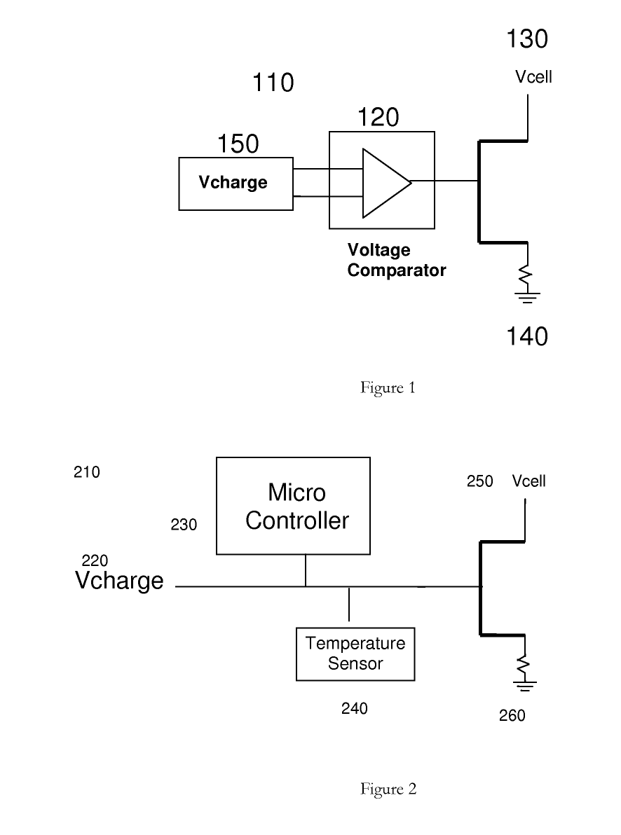

As represented in FIG. 1, the typical battery management systems (110) includes a battery or cells within a battery box (130), a voltage comparator (120), a bleed off resistor (140) and a charging voltage (150). In such a traditional system in the event the voltage from the voltage cell (130) came to a level which represents full charge the voltage comparator (120) consistently compares the charging voltage (150) to the voltage of the cell (130) and in the event the voltage of the cell (130) has reached desired voltage level representing the cell is fully charged the shunt resister (140) is connected to the charging voltage (150) thereby bleeding off the charging voltage such that the battery cell is not overly charged.

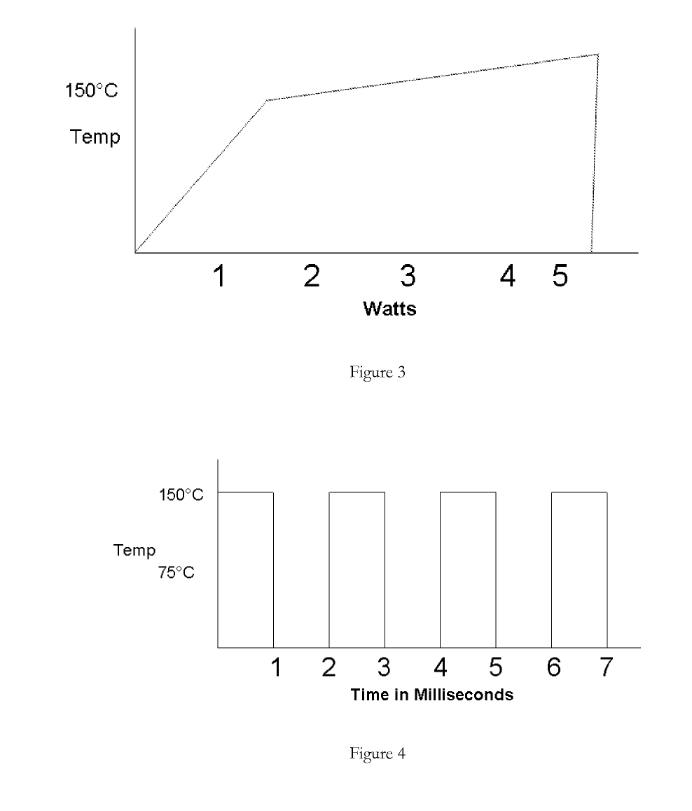

FIG. 2, represents one embodiment of the present invention of a battery management system 210, whereby the charging voltage (220) is smartly connected to a cell (250) and the resistor (260) such that the micro controller (230) is enabled to disconnect the bleed off resistor (260) in the event the temperature of the bleed off resistor is too high as read by the temperature sensor (240). In practice, the micro controller (230) is smartly configured to connect and disconnect the bleed off resistor (260) such that the bleed off resistor (160) can bleed off any charging voltage supplied to the cell (250). In the event the cell (250) becomes fully charged the micro controller (230) will connect the bleed off resistor (260) to bleed off unwanted energy thereby protecting the cell (250) from becoming over charged. In the event the bleed off resister (240) is bleeding off to much energy the temperature of the bleed off resistor (240) can exceed the limitations of the bleed off resistor (260) causing it to fail or turn off thereby leaving the cell vulnerable to overcharging. Under the present invention when the bleed off resistor (260) exceeds its limitation in temperature as represented in FIG. 3 as 150 degrees Celsius the bleed off resistor is then disconnected. This leaves the charging voltage to remain high and causing over charging of the cell.

As represented in FIG. 4 which is another preferred embodiment of the present invention where the micro controller can be smartly configured to pulse the bleed off resistor. This pulsing can occur at a frequency where the connection, between zero milliseconds and one millisecond and the disconnection between one millisecond and two milliseconds is one cycle. Such cycle time can vary from a microsecond to sixty minutes depending on the temperature level. As mentioned herein the temperature level depends on the amount of current being bleed off from the cell but it can also depend on other factors like environment temperatures. As represented in FIG. 4, and under the present invention once the bleed off resistor has reached its maximum limitation of bleeding off energy which is represented in FIG. 4 by the limitation of heat of 150 degrees Celsius the micro controller can turn off the bleed off resistor for a short time, one millisecond, thereby allowing the bleed off resistor to cool. Once the bleed off resistor has cooled the micro controller is smartly configured to reconnect the bleed off resistor for one millisecond to bleed off additional energy thereby pulsing the bleed off resistor. This enables continued protection of the battery while maintaining the temperature of the bleed off resistor at a desired state. Furthermore, with the pulsing of the bleed off resistor and the input of the temperature one can exceed the maximum wattage of the bleed of resistor for a short time as long as the temperature of the bleed off resistor is kept at desired levels. This enables one to allow high amounts of charging voltage for a short about of time thereby enabling quicker charging of the battery string.

What is claimed is:

1. A battery management system for managing the charging of cells, the system comprising:
a bleed off resistor;
a micro controller for controlling; and
a temperature sensor
wherein the microcontroller is smartly configured to connect and disconnect the bleed off resistor when the temperature of the bleed of resister becomes too high.

2. A battery management system of claim 1, wherein the connect and disconnect of the bleed off resister is pulsed such that the cycle is occurring between one millisecond and sixty minutes.

3. A method for managing the charging of cells, the system comprising:
a bleed off resistor;
a micro controller for controlling; and
a temperature sensor
wherein the microcontroller is smartly configured to exceed the maximum wattage of the bleed off resistor while keeping the desired temperature by pulsing the bleed off resistor connection to the cell.

4. A battery management system of claim 3, wherein pulsing occurs between one microsecond and sixty minutes.

5. A battery management system of claim 4, wherein the battery string is more quickly charged.
